(19) United States
(12) Patent Application Publication
(10) Pub. No.: US 2022/0009065 A1
(43) Pub. Date: Jan. 13, 2022

(54) Dolly Arm Release Tool

(71) Applicant: Raymond Paul Carnes, II, Indianapolis, IN (US)

(72) Inventor: Raymond Paul Carnes, II, Indianapolis, IN (US)

(21) Appl. No.: 17/369,792

(22) Filed: Jul. 7, 2021

Related U.S. Application Data
(60) Provisional application No. 63/049,013, filed on Jul. 7, 2020.

(51) Int. Cl. B25B 27/00; B62D 53/08

(52) U.S. Cl. CPC B25B 27/0035; B62D 53/08

(57) ABSTRACT

The dolly arm release tool is a tool that safely releases the dolly arm on a set of trailers allowing the operator to have three points of contact throughout the entirety of movement. As described above, the dolly arm release tool streamlines two useful applications into one tool and allows the operator the ability to carry only one piece of equipment to accomplish multiple tasks.

### CROSS-REFERENCE TO RELATED APPLICATIONS

This patent application claims priority to co-pending U.S. Provisional Patent Application Ser. No. 63/049,013, filed on Jul. 7, 2020.

### BACKGROUND

The main point of physical contact between a commercial truck and its trailer, and/or other hauling vehicles and components, is where the fifth wheel on the truck couples with the kingpin of the trailer. The fifth wheel is the flat slotted or grooved, horseshoe-shaped part that is directly behind the cab of a truck and between the wheels. The kingpin is a small piece of steel, which juts out below a trailer. It's attached to an apron of the trailer, or a plate of steel in the front of the trailer.

The use of double or triple trailers (or other combinations) can allow for more payload to be moved per gallon of fuel. However, a dolly and electrical and air equipment are needed to attach one trailer to another. A converter gear or dolly is a coupling device of one or two axles and a fifth wheel by which a semitrailer can be coupled to the rear of a tractor-trailer combination forming a double bottom rig.

As should be appreciated, coupling and decoupling these components can be very dangerous, in part because of the location of the coupling/decoupling, the weight of the components, and the force required to perform the tasks to complete the coupling and the decoupling.

The present disclosure is directed to one or more issues identified above.

### SUMMARY

According to an aspect of the present disclosure, a dolly arm release tool allows an operator, such as a tractor/trailer operator, the ability to more safely complete duties associated with coupling and/or decoupling hauling vehicles, components and parts using one combination tool. In one arrangement, the tractor/trailer operator may be coupling and/or decoupling double or triple trailers, which increases the safety risks involved.

According to a particular embodiment, the dolly arm release tool includes a T-shaped handle connected at one end of a long shaft and, toward the other end of the shaft, the dolly arm release tool includes a fifth wheel release feature and a dolly arm release feature.

### BRIEF DESCRIPTION OF THE DRAWINGS

The figures, provided with the present disclosure, include various views of an embodiment of the dolly arm release tool disclosed herein. The size of the tool can be altered to the specifications of the user.

FIG. 1 shows a perspective view of an embodiment of the present disclosure.

FIG. 2 shows a side view of the embodiment of the present disclosure.

FIG. 3 shows a front view of the embodiment of the present disclosure.

FIG. 4 shows a rear view of the embodiment of the present disclosure.

FIG. 5 shows a top view of the embodiment of the present disclosure.

FIG. 6 shows a bottom view of the embodiment of the present disclosure.

### DETAILED DESCRIPTION

Before the present methods, implementations, and systems are disclosed and described, it is to be understood that this invention is not limited to specific implementations, and as such may, of course, vary. It is also to be understood that the terminology used herein is for the purpose of describing particular implementations only and is not intended to be limiting.

As used in the specification and the claims, the singular forms “a,” “an” and “the” include plural references unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

The dolly arm release tool is a piece of equipment that allows an operator to perform critical functions while maintaining a safe posture and distance when disengaging the dolly arm for a set of trailers. The tool is versatile and may be used in many fields, including, for example, transportation, aviation and agriculture.

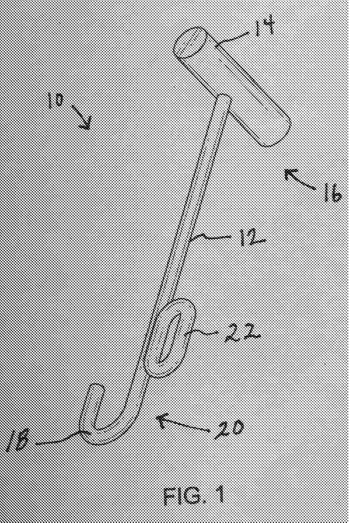

With reference to a perspective view of FIG. 1, a hand-operated dolly arm release tool 10, according to the present disclosure, includes a main body shaft tube 12, a torque handle 14 on one end 16 of the shaft tube 12, a fifth wheel release hook 18 positioned at the end 20 of the shaft tube 12 opposite the torque handle 14, and a dolly arm release loop 22 extending from the shaft tube 12, as shown, between the fifth wheel release hook 18 and the torque handle 14.

The fifth wheel release hook 18 may hook on a lever of a fifth wheel that may be released to decouple a kingpin of a coupled trailer, for example. For fifth wheel dollies, the dolly may include a dolly arm, positioned at an end of the fifth wheel opposite the groove. The dolly arm may be manipulated using the dolly arm release tool 10 by positioning the dolly arm release loop 22 around the dolly arm to move the arm between locked and unlocked positions.

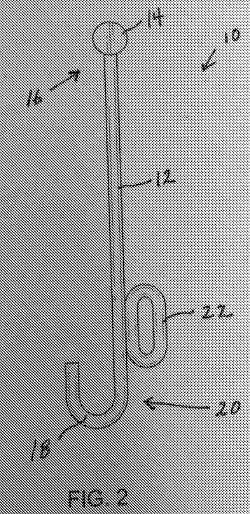

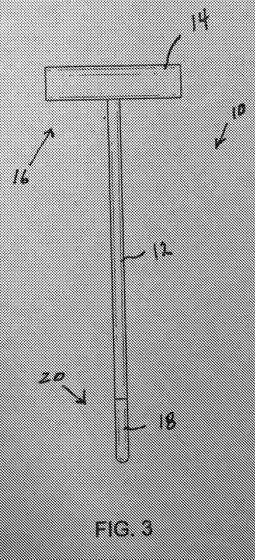

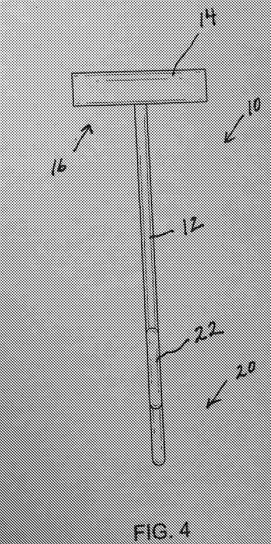

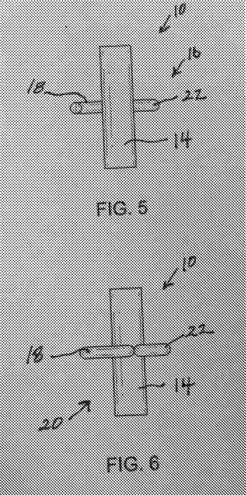

FIG. 2 shows a side view of the embodiment of the present disclosure. FIG. 3 shows a front view of the embodiment of the present disclosure. FIG. 4 shows a rear view of the embodiment of the present disclosure. FIG. 5 shows a top view of the embodiment of the present disclosure. FIG. 6 shows a bottom view of the embodiment of the present disclosure.

The dolly arm release tool 10 can be manufactured at various lengths and weights depending on the application it is being used for. The fifth wheel release hook 18 can be made for general use and the dolly arm release loop, or clip, 22 can be made at any size desired for use by operators. The material that the dolly arm release tool is made of varies depending on the specs that the operator deems necessary.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

I/We claim:

1. A hand-operated dolly arm release tool, including:
a main body shaft tube;
a torque handle on one end of the shaft tube;
wherein the shaft tube extends from the handle and terminates in a fifth wheel release hook; and
a dolly arm release loop extends from the shaft tube between the fifth wheel release hook and the torque handle.
